(19) United States
(12) Patent Application Publication
(10) Pub. No.: US 2025/0221514 A1
(43) Pub. Date: Jul. 10, 2025

(54) SYSTEM AND METHOD FOR AUTOMATED HAIRCUTTING

(71) Applicant: Joseph AVNEYA, Petach Tiqva (IL)

(72) Inventor: Rami BLICH, Maalot-Tarshicha (IL)

(21) Appl. No.: 18/847,520

(22) PCT Filed: Mar. 14, 2023
(86) PCT No.: PCT/IB2023/052479

§ 371 Date: Sep. 16, 2024

Related U.S. Application Data
(60) Provisional application No. 63/319,396, filed on Mar. 14, 2022.

(51) Int. Cl. A45D 44/02; A45D 44/00; B25J 9/16; B25J 11/00

(52) U.S. Cl. CPC A45D 44/02; A45D 44/005; B25J 9/1697; B25J 11/0055

(57) ABSTRACT

Disclosed herein are systems and methods for automated haircutting by a computer-controlled haircutting system. In the present disclosure a haircutting system may include a base; a support arm moveably attached to the base; a robot arm moveably mounted on the support arm; a cutting head mounted on the robot arm; a sensor arc attached to the base and including sensors; and a processor configured to direct the movement of the support arm, robot arm, and cutting head to cut the hair of a customer based on data received from the sensors.

### FIELD

The present invention relates to the field of cutting hair and, more particularly, to an automated haircutting system.

### BACKGROUND

Getting a haircut can be a time-consuming process. A person wanting a haircut must make an appointment with a barber/hairdresser, then travel to the location of the hairdresser, then wait while a human hairdresser cuts their hair. Being human, the hairdresser will almost never manage to duplicate a previous haircut.

It would be more convenient to get a haircut, for example, while travelling to work or some other destination, or at any time without needing to make or keep an appointment. However, human hairdressers are generally not available everywhere or at every convenient time.

### SUMMARY

Disclosed herein are systems and methods for automated haircutting. In the present disclosure a haircutting assembly may be mounted on a chair and may include cutting assemblies mounted on moveable robot and support arms. The disclosed haircutting system may have the following advantages:
The haircutting system may perform haircuts with no danger to customers, providing constant sensor feedback and an emergency stop button;
In some embodiments, the haircutting system may provide for cleaning and disinfecting between customers;
In some embodiments, a UPS (uninterruptable power supply) may enable continued operation of the haircutting system in cases of a mains power failure;
In some embodiments, the haircutting system may be configured to be resilient and survive impacts, movement, and/or exposure to water;
In some embodiments, the haircutting system may be assembled by an inexperienced person, as the system has minimal parts;
The haircutting system may be configured for simple operation by a customer;
In some embodiments, the operation of the haircutting system for providing a haircut may take place with no human involvement (aside from the customer whose hair is cut);
In some embodiments, the haircutting system may be configured for self-maintenance on a continual basis including cleaning and disinfecting and replacing of cutting blades automatically;
In some embodiments, the haircutting system may adapt the haircutting to suit different sized individuals from children to adults.

Advantageously, the haircutting system may position itself relative to the user's head, and may move in accordance with the specific head structure without harming the user. The hair cutting of the haircutting system may function irrespective of hair length or style. Yet further the reduced number of components that make up the haircutting system may ensure simplicity of operation and maintenance. It is contemplated that the haircutting device disclosed herein may be deployed for self-service operation in convenient public areas or private homes without the need for appointments. In some embodiments, the haircutting system may provide duplicatable fast haircuts. As used herein the term “customer” refers to a human subject that is receiving a haircut.

Consistent with disclosed embodiments, a haircutting system may include: a base; a support arm moveably attached to the base; a robot arm moveably mounted on the support arm; a cutting head mounted on the robot arm; a sensor arc attached to the base and including sensors; and a processor configured to direct the movement of the support arm, robot arm, and cutting head to cut the hair of a customer based on data received from the sensors. In some embodiments, the system is mounted on a chair.

In some embodiments, the support arm includes a rail and the robot arm is mounted in the rail. In some embodiments, the sensor arc is positioned above the head of a customer. In some embodiments, the cutting head is configured to move around the head of a customer to any required point on the head of the customer. In some embodiments, the robot arm includes four or more segments to provide for movement in at least four rotations.

In some embodiments, the support arms include openings in fluid communication with a fan configured to blow or suck cut hair away from the customer. In some embodiments, the cutting head includes one or more of an electric razor, electric clippers, rotating or moving blades, or adjustable screens.

In some embodiments, the controller uses of computer vision techniques to interpret visual data provided by the sensors.

In some embodiments, the system further includes face holders configured to hold the customer head stable during a haircut. In some embodiments, the support arms are configured to open for ingress or egress of a customer and to close once the customer is seated. In some embodiments, the face holders are formed to generally fit around a customer face and make contact from a front of a customer's ears and along and under a customer jaw.

In some embodiments, the system further includes a system control panel and/or a mobile device configured for selecting the style of haircut and/or desired hair length. In some embodiments, the system further includes a system control panel and/or a mobile device including an emergency stop button. In some embodiments, the controller is configured to restart a haircut process from a point where a customer stopped or paused the haircut process.

In some embodiments, the system further includes a cleaning and disinfection system for cleaning of the system after every haircut.

Consistent with disclosed embodiments, a method for automated cutting of a customer's hair may include: providing the haircutting system described hereinabove, and operating the haircutting system to cut the customer's hair according to a selected haircut style and/or length.

In some embodiments, the haircut style and/or length are selected using the system control panel or mobile device. In some embodiments, the operating includes moving the face holders to hold a customer head in place. In some embodiments, the operating includes scanning a customer head and hair by the sensors and providing scanned data to the controller. In some embodiments, the operating includes, by the controller, planning movement of the cutting heads and robot arms according to data provided by the sensors and also according to the selected haircut style and/or length. In some embodiments, the operating includes moving and activating the robot arms and the cutting heads to perform the haircut.

This Summary is provided to introduce a selection of concepts in a simplified form that are further described below in the Detailed Description below. It may be understood that this Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings, and from the claims.

### BRIEF DESCRIPTION OF THE DRAWINGS

Aspects, embodiments, and features disclosed herein will become apparent from the following detailed description when considered in conjunction with the accompanying drawings.

FIGS. 1A-1H show exemplary drawings of an automated haircutting system according to some embodiments.

FIG. 2 is a flow diagram of an example process for cutting a customer's hair using a haircutting system according to some embodiments.

### DETAILED DESCRIPTION

Reference will now be made in detail to non-limiting examples of this disclosure, examples of which are illustrated in the accompanying drawings. The examples are described below by referring to the drawings, wherein like reference numerals refer to like elements. When like reference numerals are shown, corresponding description(s) are not repeated, and the interested reader is referred to the previously discussed figure(s) for a description of the like element(s).

Aspects of this disclosure may provide a technical solution to the challenging technical problem of automated haircuts and may relate to a system for providing automated haircut systems having at least one processor (e.g., processor, processing circuit or other processing structure described herein), including methods, systems, devices, and computer-readable media. For ease of discussion, example methods performed by the haircutting system are described below with the understanding that aspects of the example methods apply equally to systems, devices, and computer-readable media. For example, some aspects of such methods may be implemented by a computing device or software running thereon. The computing device may include at least one processor (e.g., a CPU, GPU, DSP, FPGA, ASIC, or any circuitry for performing logical operations on input data) to perform the example methods.

As another example, some aspects of such methods may be implemented as operations or program codes in a non-transitory computer-readable medium. The operations or program codes may be executed by at least one processor. Non-transitory computer readable media, as described herein, may be implemented as any combination of hardware, firmware, software, or any medium capable of storing data that is readable by any computing device with a processor for performing methods or operations represented by the stored data. In a broadest sense, the example methods are not limited to particular physical or electronic instrumentalities, but rather may be accomplished using many differing instrumentalities.

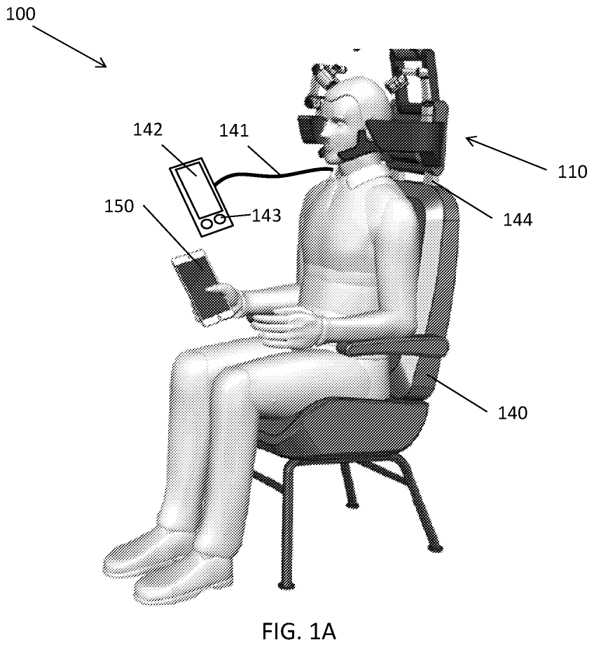

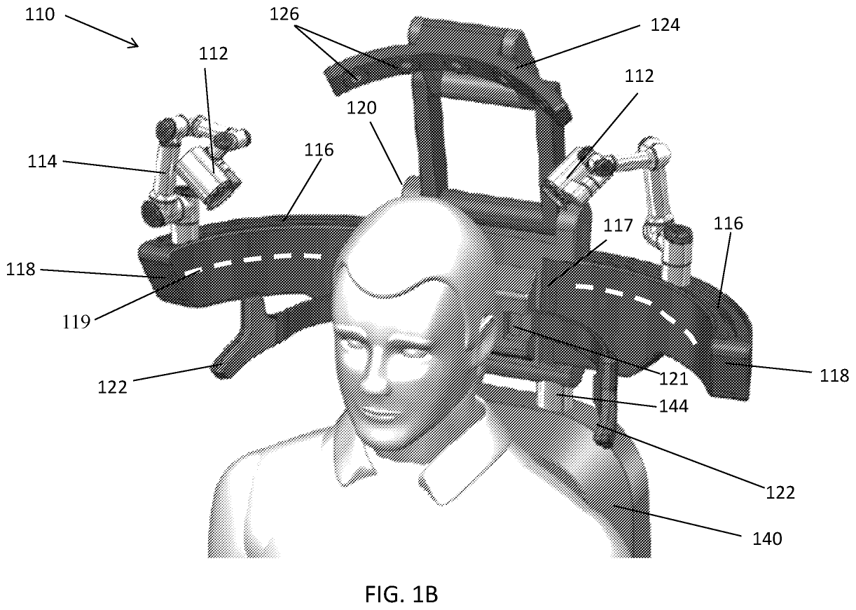

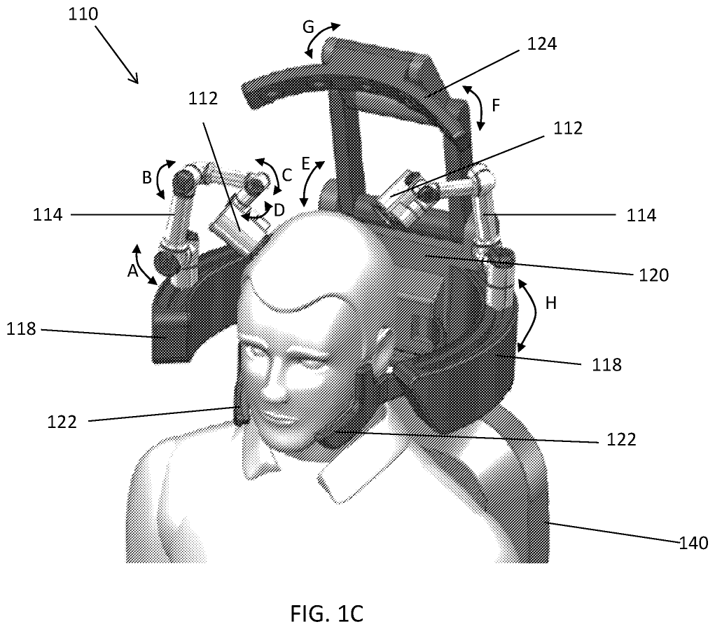

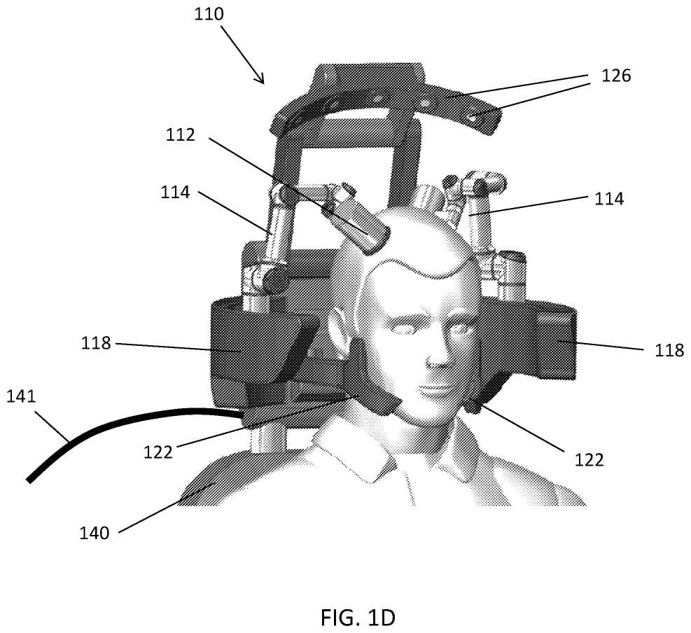

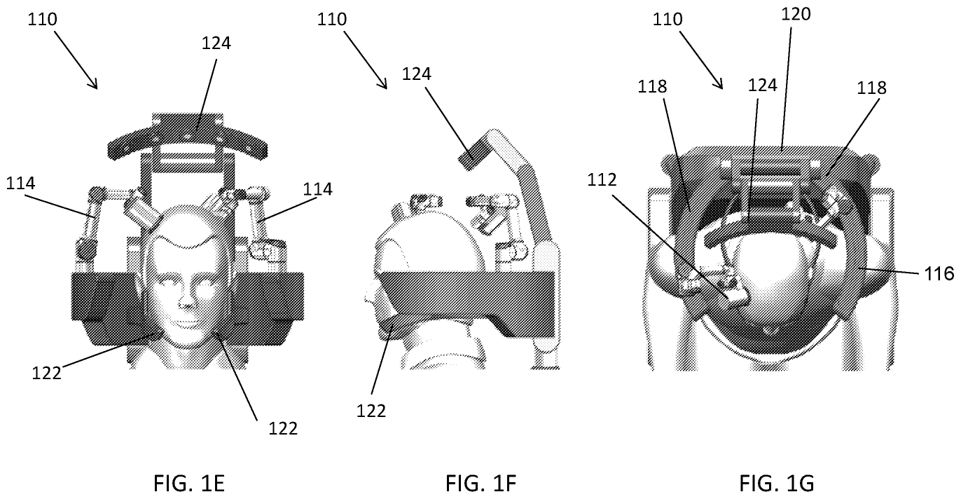

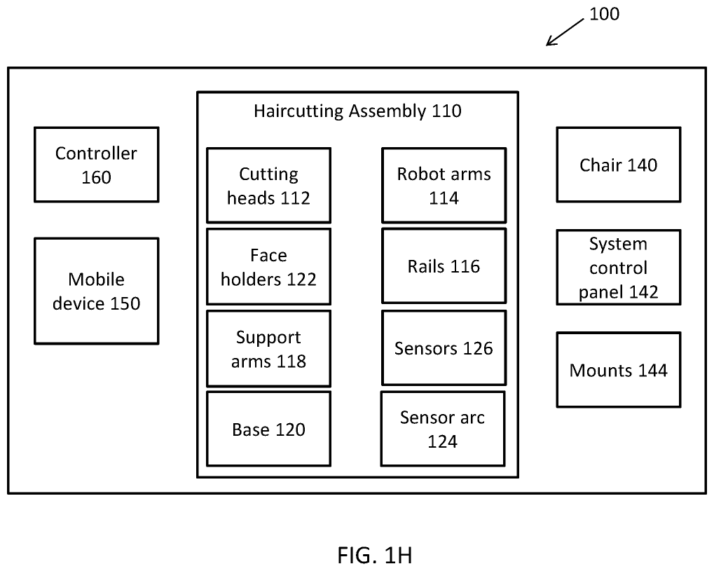

FIGS. 1A-1G show exemplary drawings of an automated haircutting system 100 according to some embodiments. FIG. 1H shows a block diagram of an automated haircutting system 100 according to some embodiments. As shown in FIGS. 1A-1H, haircutting system 100 may include a haircutting assembly 110, a system control panel 142, a mobile device 150, and a controller 160. In some embodiments, haircutting system 100 may be mounted on a chair 140. In some embodiments, chair 140 may be provided as part of system 100. In some embodiments, chair 140 is any suitable chair. In some embodiments, chair 140 is a standard barber chair. The positioning of the various components as shown in FIGS. 1A-1H is exemplary and may be altered according to the operational needs of system 100.

Haircutting assembly 110 may include one or more cutting heads 112 mounted on robot arms 114 for moving over a head while performing a haircut. Robot arms 114 may in turn be mounted on rails 116 that are positioned within support arms 118. Support arms 118 may be moveably mounted on base 120 and pivot therefrom on electronically controlled hinges/pivots 117. Face holders 122 may be moveably mounted on base 120 and pivot therefrom on electronically controlled hinges/pivots 121.

As shown, haircutting assembly 110 may be mounted onto chair 140 using mounts 144. In some embodiments, mounts 144 may be adapted for positioning or mounting haircutting assembly 110 onto a surface (not shown) other than chair 140.

Extending from base 120 and mounted above robot arms 114, a sensor arc 124 may be provided including sensors 126. Sensor arc 124 may be mounted to base and include electronic pivots/hinges so as to move in a directions indicated by arrows E, F or Gin order to move sensor arc 124 during the haircutting process. In some embodiments, sensor arc 124 may be positioned vertically above the head of the customer, enabling sensors 126 to capture data about the customer head and hair and, in some embodiments, also the positions of one or more of cutting heads 112, robot arms 114, support arms 118, and face holders 122. In some embodiments, sensor arc 124 may include blowing or sucking means (such as but not limited to one or more fans) for blowing or sucking cut hair away from the customer. Sensors 126 may include but are not limited to cameras, motion sensors, IR sensors, and distance sensors.

Robot arms 114 may be manipulated by controller 160 and may include multiple planes of movement as well as movement on rails 116 as required to bring cutting heads 112 to a required position on the customer's head or required distance from the customer's head. In use, cutting heads 112 may be moved around the customer's head to any required point upon the customer's head. In some embodiments, only one robot arm may be provided. In some embodiments, the cutting head 112 range is within a 240° range extending from base 120. In some embodiments, robot arms 114 may include robot arm sensors (not shown) for sensing the position of the parts of robot arms 114 and also the position of cutting heads 112. These robot arm sensors may also include height sensors (not shown) for detecting the hair height above the customer head and for aiding in positioning cutting heads 112 on or just above the customer's head or hair. Robot arms 114 may include accurate servo motors (not shown) and position sensors (not shown) that feed back position and other data to controller 160 in real time. In some embodiments, such as shown in FIG. 1C, each robot arm may include four or more segments to provide for movement in at least four rotations such as shown by arrows A, B, C and D.

In some embodiments, support arms 118 may include openings 119 that are in fluid communication with suction or blowing means (such as but not limited to one or more fans) configured to blow or suck cut hair away from the customer and particularly the shoulders and neck of the customer.

Cutting heads 112 may be configured to cut the customer's hair. In some embodiments, only one cutting head 112 may be provided. In some embodiments, cutting heads 112 may include cutting elements similar to those used in manual (human-operated) hair trimming machines known in the art (such as an electric razor or electric clipper mechanism, and/or rotating and/or moving blades and/or adjustable screens for different hair cutting lengths).

Controller 160 may include a processor and is configured to perform instructions for operation of device 100. Controller 160 may be in data communication with the components of device 100 as described herein for controlling operation of device 100. In some embodiments, controller 160 may be mounted on chair 150. In some embodiments, controller 160 may be mounted within haircutting assembly 110. In some embodiments, controller may plan a haircut and operates all parts of assembly 110 during the haircut based on a chosen haircut style and/or length and based on a determination of the customer's hair length and position made before and during the haircut while monitoring constant feedback from sensors 126 to keep readjusting and positioning cutting heads 112. In some embodiments, controller 160 may log all activity for record keeping and for analysis. System 100 and the modules and components that are included in system 100 may include a non-transitory computer readable medium containing instructions that when executed by at least one processor are configured to perform the functions and/or operations necessary to provide the functionality described herein. While system 100 is presented herein with specific components and modules, it should be understood by one skilled in the art, that the architectural configuration of system 100 as shown may be simply one possible configuration and that other configurations with more or fewer components are possible. As referred to herein, the “components” of system 100 may include one or more of the modules shown in FIG. 1H as being included within system 100. Controller 160 may make use of computer vision (artificial intelligence) techniques to interpret visual data provided by sensors 126 and to recognize the position and shape of the customer's head and hair.

Rails 116 may be formed as semi circles mounted within support arms 118 to cover at least a 240° circumference around a customer head at the back and sides of the customer head. Rails 116 may be positioned within a few cm from the customer head when support arms 118 are closed so as to provide freedom of movement for robot arms 114 in a direction shown by arrow H (FIG. 1C) moving therein such that robot arms may bring cutting heads 112 into contact with the customer hair to be cut.

Support arms 118 may extend from base 120 positioned behind the customer's head and may be hinge mounted at hinges 117 with means for movement (not shown) and controllable by controller such that support arms 118 may open (such as shown in FIG. 1B) for ingress or egress of a customer and close (such as shown in FIG. 1C) once the customer is seated to thereby bring robot arms 114 and cutting heads 116 to a desired distance from the customer's head. In some embodiments, support arms 118 may therefore close to a distance related to the size/position of the customer's head, i.e.: not always to the same position. In some embodiments, movement of support arms 118 may be provided by pneumatic means using a compressed air system (not shown).

Face holders 122 may be mounted on base 120 and may pivot on hinges 121 to move face holders 122 to press face holders 122 gently against the face of the customer to thereby hold the customer's head stable during the haircut. In some embodiments, face holders 122 may be formed such that they generally fit around a customer face in front of the ears and along and under the jaw as shown. In some embodiments, face holders 122 may be covered with a suitable material for comfort of the customer when face holders 122 are pressed against the customer face.

In some embodiments, sensors 126 may provide visual or other information to controller 160 so as to map the head of a customer for haircutting such as determining by controller 160 the borders of the cutting area and the plans for the cutting process. In some embodiments, sensors 126 may provide data to controller 160 for monitoring the cutting process in real time such as to track what areas of hair have already been cut. In some embodiments, sensors may provide real time data for determining positioning of cutting heads 112, robot arms 114, face holders 122 and support arms 118, hair length and other data for determining the status of an ongoing haircut. In some embodiments, sensors 126 may be positioned on arc 124 and are provided in sufficient quantities in order to have visibility of robot arms 114 and the customer head even when robot arms 114 or cutting heads might block the view of some of sensors 126.

In some embodiments, system control panel 142 in data communication with controller 160 and may be used for selecting the style of haircut and desired hair length. In some embodiments, control panel 142 may include an emergency stop button 143. In some embodiments, control panel 142 may be connected to and extend from base 120 or mounts 144 or another part of system 100 and be mounted on a control panel arm 141.

In some embodiments, system 100 may include a mobile device 150 having a touch screen such as a smartphone or tablet with a haircutting app running thereon. Mobile device 150 may include a touch screen and software (an “app”) for indicating the style and length of haircut desired. Mobile device 150 may be in data communication with controller 160 for providing user choices regarding hair style and length to controller 160 and for providing other information needed for managing the haircut process opposite the customer (for example, payment). In some embodiments, control panel 142 and mobile device 150 are computing devices and include interface functionality as known in the art such as but not limited to touch screens, displays, control buttons, audio input and output devices, and so forth.

In some embodiments, controller 160 may provide, such as via control panel 142 and/or mobile device 150 an AI-based audio chat functionality enabling a customer to “converse” with system 100 while having a haircut. In some embodiments, controller 160 may provide, such as via control panel 142 and/or mobile device 150 audiovisual content such as music or videos for customer.

In some embodiments, a mirror may be positioned in front of the customer as is customary in a haircutting salon. In some embodiments, control panel 142 or mobile device 150 may display a view of the customer's hair such as captured by sensors 126. In some embodiments, system 100 may include safety mechanisms, for example, in some embodiments, control panel 142 and/or mobile device 150 may include an emergency stop or pause button (such as button 143) to stop the haircut process and open support arms 118 so that a customer can quickly exit system 100. In some embodiments, when a haircut is stopped or paused, controller 160 may provide for restart of the haircut from where the customer stopped the process. In some embodiments, system 100 may include a battery and UPS (not shown) to enable continued working when mains power fails.

In some embodiments, system 100 may include a cleaning and disinfection system (not shown) for cleaning of system 100 after every use, optionally with compressed air and a disinfectant spray. In some embodiments, cutting heads 112 may include a cleaning and disinfection system for cleaning cutting heads 112 between haircuts.

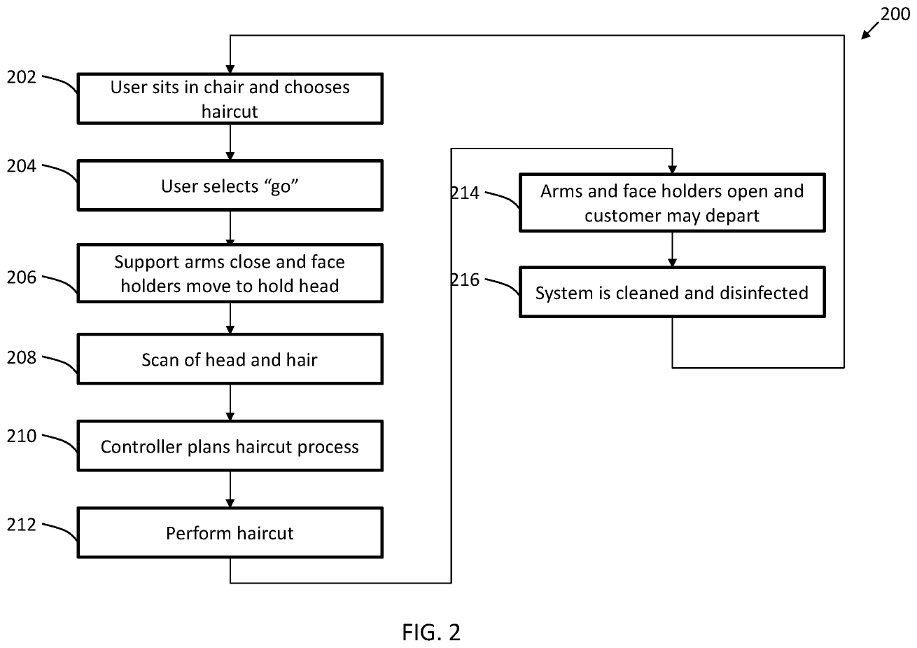

FIG. 2 is a flow diagram of an example process 200 for cutting a customer's hair using a hair cutting system according to some embodiments. This method 300 may for example be performed by system 100 described above. A non-transitory computer readable medium may contain instructions that when executed by at least one processor such as the controller 160 herein causes a haircutting system 100 to cut a customer's hair. Where process 200 refers to operation of system 100 or a haircutting system this should be understood as referring to operation of the components of system 100 that may be controlled by controller 160.

In step 202, a customer may sit in chair 140 and uses mobile device 150 and/or system control panel 142 to select the desired haircut style as well as desired hair length. In step 204, the user may press a start button or indicator on mobile device 150 and/or system control panel 142 and optionally provides payment instructions.

In step 206, face holders 122 may move to hold the head of the customer while support arms 118 may move to position robot arms 114 and cutting heads 112 an appropriate distance from the head of the customer. In some embodiments, means may be provided for placing a cloth or other material covering over the neck of the customer to prevent hair from covering the user. In some embodiments, robot arms 114 may move on tracks 116 to initial cutting positions.

In step 208, the customer head and hair may be scanned by sensors 126 and data from sensors 126 may be provided to controller 160. In step 210, controller 160 may plan movement of cutting heads 112 and robot arms 114 according to data provided by sensors 126 and also the type and length of haircut chosen by the customer.

In step 212, the haircut is performed by moving and activating robot arms 114 and cutting heads 112. For example, robot arm 114 may move cutting head 112 to a specific position and lower cutting head 112 till cutting head 112 makes contact with hair to be cut, then activating cutting head 112 (switching on a razor or clipper mechanism) to actually cut the hair to the determined length, then repeating the cutting process or simply moving cutting head 112 continually while it is activated to cut the hair while moving, optionally while altering the height of cutting head 112 relative to the hair to be cut. In some embodiments, controller 160 may monitor and gets feedback in real time about the haircut status using the various system sensors such as sensors 126 and may adjust the movements and activation of robot arms 114 and cutting heads 112 if necessary. In some embodiments, fans or vacuum means in support arms 118 and sensor arc 124 may be activated to blow or suck away cut hair, The process 200 may proceed until the controller determines that the haircut has been completed.

In step 214, the support arms 118 may open and the customer may leave chair 140 having received a haircut. In step 216, system 100 may be cleaned and disinfected and process 200 may be repeated for the next customer.

According to some embodiments, a memory may include one or more types of computer-readable storage media. A memory may include transactional memory and/or long-term storage memory facilities and may function as file storage, document storage, program storage, or as a working memory. The latter may for example be in the form of a static random access memory (SRAM), dynamic random access memory (DRAM), read-only memory (ROM), cache and/or flash memory. As working memory, temporally-based and/or non-temporally based instructions may be included. As long-term memory, a volatile or non-volatile computer storage medium, a hard disk drive, a solid state drive, a magnetic storage medium, a flash memory and/or other storage facility may be employed. A hardware memory facility may for example store a fixed information set (e.g., software code) including, but not limited to, a file, program, application, source code, object code, data, and/or the like.

The term “processor”, as used herein, may additionally or alternatively refer to a controller. A processor may be implemented by various types of processor devices and/or processor architectures including, for example, embedded processors, communication processors, graphics processing unit (GPU)-accelerated computing, soft-core processors and/or general purpose processors.

Unless otherwise defined, all technical and scientific terms used herein have the same meaning as commonly understood by one of ordinary skill in the art. The materials, methods, and examples provided herein are illustrative only and not intended to be limiting.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a processor chip or a circuit. As software or algorithm, selected steps of the disclosure could be implemented as a plurality of software instructions being executed by a computer/processor using any suitable operating system. In any case, selected steps of the method and system of the disclosure could be described as being performed by a data processor, such as a computing device for executing a plurality of instructions.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally form a “network” or a “computer network”.

To provide for interaction with a user, the systems and techniques described here can be implemented on a computing device having a display (indicator/monitor/screen/array) (such as a LED (light-emitting diode), OLED (organic LED), LCD (liquid crystal display) or other display technology) for displaying information to the user and a keyboard and a pointing device (e.g., a mouse, joystick or a trackball) or individual buttons/knobs/levers (such as driving wheel buttons/signaling levers) by which the user can provide input to the computing device. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, analysis of user head position and/or eye movements, or tactile input.

It should be appreciated that the above-described methods and apparatus may be varied in many ways, including omitting, or adding steps, changing the order of steps and the type of devices used. It should be appreciated that different features may be combined in different ways. In particular, not all the features shown above in a particular embodiment or implementation are necessary in every embodiment or implementation of the disclosure. Further combinations of the above features and implementations are also considered to be within the scope of some embodiments or implementations of the disclosure.

It is important to note that the methods described herein and illustrated in the accompanying diagrams shall not be construed in a limiting manner. For example, methods described herein may include additional or even fewer processes or operations in comparison to what is described herein and/or illustrated in the diagrams. In addition, method steps are not necessarily limited to the chronological order as illustrated and described herein.

Any computing device, digital computer system, unit, device, module and/or engine exemplified herein can be configured or otherwise programmed to implement a method disclosed herein, and to the extent that the system, module and/or engine is configured to implement such a method, it is within the scope and spirit of the disclosure. Once the system, module and/or engine are programmed to perform particular functions pursuant to computer readable and executable instructions from program software that implements a method disclosed herein, it in effect becomes a special purpose computer particular to embodiments of the method disclosed herein. The methods and/or processes disclosed herein may be implemented as a computer program product that may be tangibly embodied in an information carrier including, for example, in a non-transitory tangible computer-readable and/or non-transitory tangible machine-readable storage device. The computer program product may be directly loadable into an internal memory of a digital computer, comprising software code portions for performing the methods and/or processes as disclosed herein.

The methods and/or processes disclosed herein may be implemented as a computer program that may be intangibly embodied by a computer readable signal medium. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer or machine-readable storage device and that can communicate, propagate, or transport a program for use by or in connection with apparatuses, systems, platforms, methods, operations and/or processes discussed herein.

The terms “non-transitory computer-readable storage device” and “non-transitory machine-readable storage device” encompasses distribution media, intermediate storage media, execution memory of a computer, and any other medium or device capable of storing for later reading by a computer program implementing embodiments of a method disclosed herein. A computer program product can be deployed to be executed on one computer or on multiple computers at one site or distributed across multiple sites and interconnected by one or more communication networks.

These computer readable and executable instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable and executable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable and executable instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The term “engine” may comprise one or more computer modules, wherein a module may be a self-contained hardware and/or software component that interfaces with a larger system. A module may comprise a machine or machines executable instructions. A module may be embodied by a circuit or a controller programmed to cause the system to implement the method, process and/or operation as disclosed herein. For example, a module may be implemented as a hardware circuit comprising, e.g., custom VLSI circuits or gate arrays, an application-specific integrated circuit (ASIC), off-the-shelf semiconductors such as logic chips, transistors, and/or other discrete components. A module may also be implemented in programmable hardware devices such as field programmable gate arrays, programmable array logic, programmable logic devices and/or the like.

The term “random” also encompasses the meaning of the term “substantially randomly” or “pseudo-randomly”.

In the discussion, unless otherwise stated, adjectives such as “substantially” and “about” that modify a condition or relationship characteristic of a feature or features of an embodiment of the invention, are to be understood to mean that the condition or characteristic is defined to within tolerances that are acceptable for operation of the embodiment for an application for which it is intended.

Unless otherwise specified, the terms “substantially”, “‘about” and/or “close” with respect to a magnitude or a numerical value may imply to be within an inclusive range of −10% to +10% of the respective magnitude or value.

“Coupled with” can mean indirectly or directly “coupled with”.

It is important to note that the method may include is not limited to those diagrams or to the corresponding descriptions. For example, the method may include additional or even fewer processes or operations in comparison to what is described in the figures. In addition, embodiments of the method are not necessarily limited to the chronological order as illustrated and described herein.

Discussions herein utilizing terms such as, for example, “processing”, “computing”, “calculating”, “determining”, “establishing”, “analyzing”, “checking”, “estimating”, “deriving”, “selecting”, “inferring” or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes. The term determining may, where applicable, also refer to “heuristically determining”.

It should be noted that where an embodiment refers to a condition of “above a threshold”, this should not be construed as excluding an embodiment referring to a condition of “equal or above a threshold”. Analogously, where an embodiment refers to a condition “below a threshold”, this should not be construed as excluding an embodiment referring to a condition “equal or below a threshold”. It is clear that should a condition be interpreted as being fulfilled if the value of a given parameter is above a threshold, then the same condition is considered as not being fulfilled if the value of the given parameter is equal or below the given threshold. Conversely, should a condition be interpreted as being fulfilled if the value of a given parameter is equal or above a threshold, then the same condition is considered as not being fulfilled if the value of the given parameter is below (and only below) the given threshold.

It should be understood that where the claims or specification refer to “a” or “an” element and/or feature, such reference is not to be construed as there being only one of that element. Hence, reference to “an element” or “at least one element” for instance may also encompass “one or more elements”.

Terms used in the singular shall also include the plural, except where expressly otherwise stated or where the context otherwise requires.

In the description and claims of the present application, each of the verbs, “comprise” “include” and “have”, and conjugates thereof, are used to indicate that the data portion or data portions of the verb are not necessarily a complete listing of components, elements or parts of the subject or subjects of the verb.

Unless otherwise stated, the use of the expression “and/or” between the last two members of a list of options for selection indicates that a selection of one or more of the listed options is appropriate and may be made. Further, the use of the expression “and/or” may be used interchangeably with the expressions “at least one of the following”, “any one of the following” or “one or more of the following”, followed by a listing of the various options.

As used herein, the phrase “A, B, C, or any combination of the aforesaid” should be interpreted as meaning all of the following: (i) A or B or C or any combination of A, B, and C, (ii) at least one of A, B, and C; (iii) A, and/or B and/or C, and (iv) A, B and/or C. Where appropriate, the phrase A, B and/or C can be interpreted as meaning A, B or C. The phrase A, B or C should be interpreted as meaning “selected from the group consisting of A, B and C”. This concept is illustrated for three elements (i.e., A, B, C), but extends to fewer and greater numbers of elements (e.g., A, B, C, D, etc.).

It is appreciated that certain features of the invention, which are, for clarity, described in the context of separate embodiments or example, may also be provided in combination in a single embodiment. Conversely, various features of the invention, which are, for brevity, described in the context of a single embodiment, example and/or option, may also be provided separately or in any suitable sub-combination or as suitable in any other described embodiment, example or option of the invention. Certain features described in the context of various embodiments, examples and/or optional implementation are not to be considered essential features of those embodiments, unless the embodiment, example and/or optional implementation is inoperative without those elements.

It is noted that the terms “in some embodiments”, “according to some embodiments”, “for example”, “e.g.,”, “for instance” and “optionally” may herein be used interchangeably.

The number of elements shown in the Figures should by no means be construed as limiting and is for illustrative purposes only.

It is noted that the terms “operable to” can encompass the meaning of the term “modified or configured to”. In other words, a machine “operable to” perform a task can in some embodiments, embrace a mere capability (e.g., “modified”) to perform the function and, in some other embodiments, a machine that is actually made (e.g., “configured”) to perform the function.

Throughout this application, various embodiments may be presented in and/or relate to a range format. It should be understood that the description in range format is merely for convenience and brevity and should not be construed as an inflexible limitation on the scope of the embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

As used herein the terms “machine vision”, “machine learning” or “artificial intelligence” refer to use of algorithms on a computing device that parse data, learn from the data, and then make a determination or generate data, where the determination or generated data is not deterministically replicable (such as with deterministically oriented software as known in the art).

While the invention has been described with respect to a limited number of embodiments, these should not be construed as limitations on the scope of the invention, but rather as exemplifications of some of the embodiments.

While certain features of the described implementations have been illustrated as described herein, many modifications, substitutions, changes, and equivalents will now occur to those skilled in the art. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations and embodiments described.

What is claimed is:

1. A haircutting system comprising:
a base;
a support arm moveably attached to the base;
a robot arm moveably mounted on the support arm;
a cutting head mounted on the robot arm;
a sensor arc attached to the base and including sensors; and
a processor configured to direct the movement of the support arm, robot arm, and cutting head to cut the hair of a customer based on data received from the sensors.

2. The system of claim 1, wherein the system is mounted on a chair.

3. The system of claim 1, wherein the support arm includes a rail and the robot arm is mounted in the rail.

4. The system of claim 1, wherein the sensor arc is positioned above the head of a customer.

5. The system of claim 1, wherein the cutting head is configured to move around the head of a customer to any required point on the head of the customer.

6. The system of claim 1, wherein the robot arm includes four or more segments to provide for movement in at least four rotations.

7. The system of claim 1, wherein the support arms are configured to blow or suck cut hair away from the customer.

8. The system of claim 1, wherein the cutting head includes one or more of an electric razor, electric clippers, rotating or moving blades, or adjustable screens.

9. The system of claim 1, wherein the sensor arc is configured to blow or suck cut hair away from the customer.

10. The system of claim 1, wherein the controller uses of computer vision techniques to interpret visual data provided by the sensors.

11. The system of claim 1, wherein the support arms are configured to open for ingress or egress of a customer and to close once the customer is seated.

12. The system of claim 1, further comprising face holders configured to hold the head of a customer stable during a haircut.

13. The system of claim 12, wherein the face holders are formed to generally fit around a customer face and make contact from a front of a customer's ears and along and under a customer jaw.

14. The system of claim 1, further including a system control panel and/or a mobile device configured for selecting the style of haircut and/or desired hair length.

15. The system of claim 1, further including a system control panel and/or a mobile device including an emergency stop button.

16. The system of claim 1, wherein the controller is configured to restart a haircut process from a point where a customer stopped or paused the haircut process.

17. The system of claim 1, further including a cleaning and disinfection system for cleaning of the system after a haircut.

18. A method for automated cutting of a customer's hair comprising:
providing the haircutting system of any one of claims 1-17; and
operating the haircutting system to cut the customer's hair according to a selected haircut style and/or length.

19. The method of claim 18, wherein the haircut style and/or length are selected using the system control panel or mobile device.

20. The method of claim 18, wherein the operating includes moving the face holders to hold a customer head in place.

21. The method of claim 18, wherein the operating includes scanning a customer head and hair by the sensors and providing scanned data to the controller.

22. The method of claim 19, wherein the operating includes, by the controller, planning movement of the cutting heads and robot arms according to data provided by the sensors and also according to the selected haircut style and/or length.

23. The method of claim 18, wherein the operating includes moving and activating the robot arms and the cutting heads to perform the haircut.
